(19) United States
(12) Patent Application Publication
(10) Pub. No.: US 2018/0157767 A1
(43) Pub. Date: Jun. 7, 2018

(54) METHOD OF FORMING A USER QUERY

(71) Applicant: YANDEX EUROPE AG, Luzern (CH)

(72) Inventor: Maksim Andreevich BALYAN, Moscow (RU)

(21) Appl. No.: 15/830,043

(22) Filed: Dec. 4, 2017

(30) Foreign Application Priority Data
Dec. 6, 2016 (RU) 2016147668

(51) Int. Cl. G06F 17/30

(52) U.S. Cl. CPC G06F 17/30973; G06F 17/30864

(57) ABSTRACT

There is discloses a method for generating a search query suggestion. The method comprises: receiving a first user input in a query field, the first user input including at least a portion of the search query; in response to receiving the first user input, displaying a suggestion area associated with the first user input, the suggestion area comprising at least one suggestion element to form the search query; in response to receiving a second user input associated with the suggestion area, causing a visual change to the suggestion area, the visual change including moving the suggestion area associated with the first user input relative to the query field, the moving causing alignment, in a sequential order, of: a given one of the at least one suggestion element after another one of the at least one suggestion element, with the first user input.

### CROSS-REFERENCE

The present application claims priority to Russian Patent Application No. 2016147668, filed Dec. 6, 2016, entitled “Method for Forming a User Request” the entirety of which is incorporated herein.

### FIELD OF THE TECHNOLOGY

The present technology relates to search engines in general and specifically to a method of forming a user query and proving a response to a query.

### BACKGROUND

Various global or local communication networks (the Internet, the World Wide Web, local area networks and the like) offer a user a vast amount of information. The information includes a plethora of contextual topics, such as, but not limited to, news and current events, maps, company information, financial information and resources, traffic information, games and entertainment information. Users may use various client devices (desktop, laptop, notebook, smartphone, tablets and the like) to have access to rich information content (like images, audio, video, animation, and other multimedia content from such networks). For example, a user might be interested in watching a video about using algae but might not know the exact resource providing this kind of information. Or it might be the case the user is interested in finding the nearest supermarket but, again, might not know the exact resource providing this kind of search function. In these hypothetical (but possible) situations user might conduct a network search using a search engine.

While conducting a network search using a search engine, user is mainly concerned about two aspects. (S)he wants to find the most relevant results and (s)he wants the results relatively quickly. In order to solve those problems, at least partially, search engines provide a user with suggestions to form a query, as is known in the art. For example, in response to the user input “algae” into Google™ search engine, user is provided with a list of suggestions in a drop-down menu, namely “algae in aquarium”, “algae types”, “algae names”.

The main idea of the search query suggestions is to simplify user experience and to provide the user with a more convenient and functional interface. There are situations in which, while selecting the suggestion to form a user query, the user may find it challenging to select the search query suggestion from the list of proposed search query suggestions. This problem is particularly acute if (s)he using a touch-screen of a portable mobile device. Particularly, if the user is in a moving vehicle or moves through a crowded space, (s)he often has difficulty trying to concentrate his/her attention on suggestions offered to be selected in a query field, as well as has difficulty while performing actions with the offered suggestions. The user has to be pay special attention to select the desired line with this suggestion, which might be difficult in an unstable environment. This is why the present technology is relevant in any other cases when a user has vision or movement limitations or any other physical limitations, or when a user has a short amount of time and needs to form his/her query as quickly as possible using the suggestions. Moreover, for the applications installed on a device with a big screen, such as laptops and desktop computers, the present technology provides a larger amount and variety of suggestions, which helps to quicken the process of conducting difficult and professional searches.

US 2016/084667 filed Mar. 24, 2016, teaches a portable electronic device comprising: data processing means; data repository containing data representative of a digital map; and display means. The device further comprises means for, in relation to data representative of a plurality locations relevant to the digital map, providing, on a representation of the digital map displayed on the display, for each of the locations, one of a plurality of different graphical user interface (GUI) elements characterized by different prominence levels to indicate the locations, wherein the prominence level of the GUI element used for each location is dependent on the level of detail at which the digital map is displayed and a deemed relevance of that location to a user query.

FIG. 2 is an illustrative representation of an electronic device, a display showing a search application 104 conventional in the prior art. The search application 104 is able to work on the majority of known electronic devices (e.g. laptops, desktops, smartphones, tablets, etc.) Screenshot 202 depicts a search application 104 being a browser in this case for the ease of illustration. Nonetheless, a person skilled in the art is well informed about any other search application 104, for example, browsers Google™Chrome™, MozillaFirefox™, Yandex.Browser™, and many others commercially available or proprietary browsers.

Regardless of the exact search application 104 used, it usually has a query interface 106, a search result interface 108 and a suggestion area 202.

Usually, to form a query, a user uses a search application 104 including the query interface 106 and the search result interface 108. The query interface 106 is a query field where a user can enter at least a first input to form a query. As it is known in the art, while forming a query, the user is provided with a suggestion area in a form of a drop-down window in the query interface 106 so that the drop-down window contains a list of suggestions and is usually statically located under the query interface 106. The query area, as well as all the suggestion elements provided in the query area, remain fixed relative to the search result interface 108. User can choose a suggestion from the suggestion list provided in the query area by clicking on the desired suggestion with a mouse (as an example), and the suggestion appears in the query field. After that, the user can click the enter button and a query is sent to a search server.

It is known in the art to form a search query using suggestions that are presented to the user for the user to select from, but the known technique appear to require the users to focus their attention on the presented suggestion choices, selecting the suggestion and, in some prior art solutions (typically those for wireless electronic devices), positioning the suggestion in the query field. To form a query, the user receives a small number of pre-selected suggestions, especially if the user forms the query on a wireless electronic device, such as, a smartphone or a tablet. In order to select the suggestion, the user needs to perform a touchscreen interaction or a mouse click on a selected suggestion of her choice, and the such-formulated query is sent to the server. In order to receive additional suggestions, the user needs to reformulate his/her query, and again (s)he receives a small number of pre-selected suggestions, and the user cannot get easily back to the previously seen suggestions (without, for example, re-typing the originally entered search query). Hence, the navigation in the search application is difficult, and the user has to formulate his/her query multiple times. In this case, server receives multiple queries from the user electronic device. As such, the search takes more time, and these multiple interactions with the sever require more energy from the wireless electronic device and increase the load on the server.

### SUMMARY

It is an object of the present technology to ameliorate at least some of the inconveniences present in the prior art.

Implementations of the present technology were developed taking into account the understanding by inventors of at least one technical problem associated with the known techniques of forming a search query.

In accordance with a first broad aspect of the present technology, there is provided a method for generating a search query suggestion, the search query suggestion for enabling forming a search query on an electronic device having a user input interface for receiving user inputs and a user output interface for providing visual outputs, a network communication interface for two-way communication over the communications network. The method comprises: receiving a first user input in a query field, the first user input including at least a portion of the search query; in response to receiving the first user input, displaying a suggestion area associated with the first user input, the suggestion area comprising at least one suggestion element to form the search query; in response to receiving a second user input associated with the suggestion area, causing a visual change to the suggestion area, the visual change including moving the suggestion area associated with the first user input relative to the query field, the moving causing alignment, in a sequential order, of: a given one of the at least one suggestion element after another one of the at least one suggestion element, with the first user input; forming the search query, the search query including the first user input and the given one of the at least one suggestion element being aligned with the first user input.

In some implementations of the method, the receiving a first user input is implemented based on one of: mouse control, keyboard control, gesture control, sensor control, voice control; the receiving triggering initiation the displaying the suggestion area.

In some implementations of the method, the receiving a second user input is implemented based on one of: mouse control, keyboard control, gesture control, sensor control, voice control; the receiving triggering initiation the movement of the suggestion area.

In some implementations of the method, the receiving the second user input using the voice control for the suggestion area comprises: selecting, by the user, a suggestion element from the suggestion element by uttering the selected suggestion element, said uttering initiating the movement of the suggestion area such that the selected suggestion element is aligned with the portion of the search query in a search field.

In some implementations of the method, the method further comprises receiving a third user input associated with a position of the suggestion area corresponding to the given one of the at least one suggestion element aligned with the portion of the search query in the query field.

In some implementations of the method, the receiving the third user input is implemented based on one of: mouse control, gesture control, sensor control, voice control to initiate movement of the suggestion area.

In some implementations of the method, the method further comprises sending the search query to the server responsive to the receiving of the third user input, the third user input identifying the given one of the at least one suggestion element.

In some implementations of the method, the third user input comprises an identification of the given one of the at least one suggestion element.

In some implementations of the method, the identification is received in response to the user stopping moving the suggestion area, the given one of the at least one suggestion element being one where the movement has stopped.

In some implementations of the method, the forming of the search query includes repeating the steps of receiving the first and the second user inputs.

In some implementations of the method, the method further comprises sending the search query to the server responsive to lack of user input for a duration of time exceeding a threshold time value associated with a position of the suggestion area corresponding to the given one of the at least one suggestion element.

In some implementations of the method, displaying the movement of the suggestion area is implemented as moving the suggestion area in a direction that is one of: substantially vertically relative to the query area, substantially horizontally relative to the query area, at least partially substantially circumferentially relative to the query area, at least partially substantially along an arc relative to the query area.

In some implementations of the method, the moving of the suggestion area comprises moving a feed list of suggestion elements across the query field such that the at least one suggestion element remains displayed after passing through the query field.

In some implementations of the method, the method further comprising in response to receiving at least the first user input, additional displaying of at least a second suggestion area associated with the first user input and containing at least one additional suggestion element for forming the search query.

In some implementations of the method, the method further comprising transmitting the at least portion of the search query, via a communication network to a search server, and receiving from the search server an indication of the at least one suggestion element.

In some implementations of the method, the at least one suggestion element has been determined, by the search server, by executing a vertical search module.

In some implementations of the method, the method further comprising displaying an indication of a web-resource determined to be relevant for the search query in the query field.

In accordance with another broad aspect of the present technology, there is provided an electronic device for user interaction, the electronic device being configured to send a query to a search server via a communication network. The electronic device comprises: a user input interface for receiving user inputs, a user output interface for providing visual outputs, a network communication interface for two-way communication over the communication network; and a processor coupled to the user input interface, the user output interface and the network communication interface, and configured to access and execute machine-readable instructions; the processor being configured to: receive a first user input in a query field, the first user input including at least a portion of the search query; in response to receiving the first user input, display a suggestion area associated with the first user input, the suggestion area comprising at least one suggestion element to form the search query; in response to receiving a second user input associated with the suggestion area, cause a visual change to the suggestion area, the visual change including moving the suggestion area associated with the first user input relative to the query field, the moving causing alignment, in a sequential order, of: a given one of the at least one suggestion element after another one of the at least one suggestion element, with the first user input; form the search query, the search query including the first user input and the given one of the at least one suggestion element being aligned with the first user input.

In another aspect, implementations of the present technology provide a method of forming a search query. Method is executed on an electronic device having a user input interface for receiving user inputs and a user output interface for providing visual outputs, a network communication interface for two-way communication over the communications network. The method includes: receiving a first user input in a query field, and the first user input includes at least a portion of a user query; displaying, responsive to receiving of the first user input, a suggestion area associated with the first user input, the suggestion area contains at least one suggestion element to form a search query; displaying, responsive to receiving a second user input associated with the suggestion area, a movement of the suggestion area, associated with the first user input, relative to the query field with the possibility of sequential at least partial aligning suggestion elements with a portion of the search query in the query field; forming the search query associated with the position of the suggestion area, associated with the first user input, relative to the query field.

In some embodiments of the method, receiving of the first user input is implemented using one of the following: mouse control, keyboard control, gesture control, sensor control, voice control to initiate displaying the suggestion area.

In some embodiments of the method, receiving of the second user input is implemented using one of the following: mouse control, keyboard control, gesture control, sensor control, voice control to initiate moving the suggestion area.

In some embodiments of the method, receiving of the second user input using the voice control for the suggestion area includes: selecting, by the user, a suggestion element from the suggestion area by pronouncing at loud the name of the selected suggestion element, said pronouncing initiates the movement of the suggestion area so that the user-selected suggestion element is aligned with a portion of the search query in a search field.

In some embodiments of the method, a third user input associated with a position of the suggestion area corresponding to the suggestion element aligned with the portion of the search query in the query field is received.

In some embodiments of the method, the receiving of the third user input is implemented using one of the following: mouse control, gesture control, sensor control, voice control to initiate moving the suggestion area.

In some embodiments of the method, the third user input is received by using the voice control on the suggestion area, including: pronouncing a command.

Some embodiments of the method include sending the search query to the server responsive to the receiving of the third user input.

In some embodiments of the method, the forming of the search query includes repeating the steps of receiving the first and the second user inputs.

In some embodiments, the method includes the sending of the search query to the server responsive to exceeding a threshold time value associated with a position of the suggestion area corresponding to the suggestion element aligned with the portion of the search query in the query field.

In some embodiments of the method, displaying the movement of the suggestion area is implemented as moving the suggestion area in one of the following directions: essentially vertically relative to the query area, essentially horizontally relative to the query area, at least partially essentially circumferentially relative to the query area, at least partially essentially along the arc relative to the query area.

In some embodiments of the method, displaying the moving of the suggestion area implemented as moving the feed list of suggestion elements across the query field with the subsequent aligning of suggestion elements with the portion of the search query in the query field so that the at least one suggestion element remains displayed after passing through the query field.

In some embodiments of the method, while displaying the moving of the suggestion area, the speed of movement of the suggestion area is variable.

In some embodiments of the method, while displaying the moving of the suggestion area, the speed of movement of the suggestion area reduces with the proximity of the query field.

In some embodiments of the method, displaying of the movement of the suggestion area includes rotation of the suggestion area with a subsequent overlapping suggestion elements and the portion of the search query in the query field so that suggestions from the suggestion area consistently pass through the query field to form one of the following: at least partially essentially circumferentially, at least partially substantially along the are.

In some embodiments, the method includes, in response to receiving at least the first user input, additional displaying of at least the second suggestion area associated with the first user input and containing at least one suggestion element for forming a search query.

In some embodiments, the method includes, responsive to receiving the second user input associated with the suggestion area, displaying of moving the second suggestion area so that while moving the second suggestion area the suggestion elements from the second suggestion area are consistently aligned with the portion of the search query in the query field.

In some embodiments, the method includes, responsive to the receiving the second user input associated with the suggestion area, displaying the movement of the first suggestion area and the second suggestion area relative to each other.

In some embodiments, the method includes, responsive to the receiving the second user input associated with the suggestion area, displaying the synchronized movement of the first suggestion area and the second suggestion area.

In some embodiments, the method includes, responsive to receiving the third user input associated with a position of the suggestion area, displaying at least one search result associated with the search query.

In some embodiments of the method, when displaying suggestion area, the suggestion elements include at least one of the following: parts of words, words, phrases, numbers, symbols, and/or a combination of all above.

In some embodiments, the method includes displaying the suggestion area, wherein the suggestion elements in the suggestion area include any of the subsequent portion of the first user input, the previous portion of the first user input and the intermediate portion of the first user input.

In some embodiments of the method, the second user input includes at least one of the following user actions: excluding the suggestion element from the suggestion area, adding the suggestion element into the suggestion area, moving the suggestion elements relative to each other in the same suggestion area, moving the suggestion element from one suggestion area to another.

In some embodiments of the method, the user action is implemented using one of the following: mouse control, keyboard control, gesture control, sensor control, voice control.

In some embodiments of the method, displaying the moving of the suggestion area includes a dynamic update of the suggestion area responsive to the user action associated with the suggestion area.

In some embodiments of the method, the dynamic update of the suggestion area occurs in response to the user action associated with the suggestion area, and includes adding additional suggestion elements and/or removing the suggestion elements from the suggestion area.

In some embodiments of the method, the dynamic update of the suggestion area occurs in response to the user action associated with the suggestion area, and includes replacement of the suggestion element taking into account a user input history.

In some embodiments of the method, the dynamic update of the suggestion area occurs in response to the user action associated with the suggestion area, and includes replacement of the suggestion element taking into account a user input history and other users' query history.

In some embodiments of the method, the dynamic update of the suggestion area, responsive to the user action associated with the suggestion area, is sensitive to the second input portion of the search query.

In some embodiments of the method, receiving of the first user input in the query field in form of at least portion of the search query sent via communication network to the server, and receiving from the server a suggestion definition to form the search query.

In some embodiments of the method, while determining the suggestion to form the search query, a vertical search module is used.

In some embodiments, the method includes determining the most appropriate response to the suggestion.

In some embodiments of the method, while determining the most appropriate response to the suggestion to form the search query, a vertical search module is used.

According to another broad aspect of the present technology, there is provided an electronic device for user interaction, which is configured to send a query via a communication network, comprising: user input interface for receiving user inputs and a user output interface for providing visual outputs, a network communication interface for two-way communication over the communications network; and a processor associated with the user input interface, the user output interface and the network communication interface, and configured to access and execute machine-readable instructions; the processor is configured to: receive a first user input in the query field, wherein the first user input includes at least a portion of a search query; in response to receiving the first user input, display a suggestion area associated with the first user input, the suggestion area comprises at least one suggestion element for forming the search query; in response to receiving the second user input associated with the suggestion area, display a movement of the suggestion area, associated with the first user input, relative to the query field with the possibility of successive at least partial aligning of the suggestion elements with a portion of the search query in the query field; form of the search request associated with the position of the suggestion area associated with the first user input relative to the query field.

According to another broad aspect of the present technology, there is provided a non-transitory computer-readable storage medium storing program instructions for execution by a processor of an electronic device, and the instructions executed by the processor of the electronic device cause: receiving a first user input in a query field, and the first user input includes at least a portion of a user query; displaying, responsive to receiving of the first user input, a suggestion area associated with the first user input, the suggestion area contains at least one suggestion element to form a search query; displaying, responsive to receiving a second user input associated with the suggestion area, a movement of the suggestion area, associated with the suggestion area, relative to the query field with the possibility of sequential at least partially aligning suggestion elements with a portion of the search query in the query field; forming the search query associated with a position of the suggestion area, associated with the first user input, relative to the query field.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a computer system 100 in accordance with an embodiment of the present technology.

FIG. 2 depicts a schematic diagram of an electronic device with a search application having a suggestion area, the search application executed by the electronic device being implemented in accordance with the known prior art techniques.

FIG. 3 depicts a schematic diagram of an electronic device of the system of FIG. 1, the electronic device executing a search application installed in accordance with non-limiting embodiments of the present technology displaying one non-limiting embodiment of the suggestion area.

FIG. 4 schematically depicts screenshots that illustrate one non-limiting embodiment of the search application, with a suggestion area shown during various steps of forming a search query.

FIG. 5 schematically depicts screenshots illustrating another non-limiting embodiment of the search application, with the suggestion area shown during various steps of forming the search query.

FIG. 6 schematically depicts screenshots illustrating one another non-limiting embodiment of the search application having two suggestion areas, the search application shown during various steps of forming the search query.

FIG. 7 schematically depicts screenshots illustrating another non-limiting embodiment of the search application with suggestion areas implemented as a tree.

FIG. 8 schematically depicts a screenshot illustrating another non-limiting embodiment of the search application with suggestion areas implemented as a tree.

FIG. 9 schematically depicts a search application implemented in accordance with an embodiment of the present technology displaying another non-limiting embodiment of the suggestion area.

FIG. 10 schematically depicts a search application implemented in accordance with yet another embodiment of the present technology displaying another non-limiting embodiment of the suggestion area.

FIG. 11 schematically depicts a block diagram of a flowchart of a method according to non-limiting embodiments of the present technology.

### DETAILED DESCRIPTION

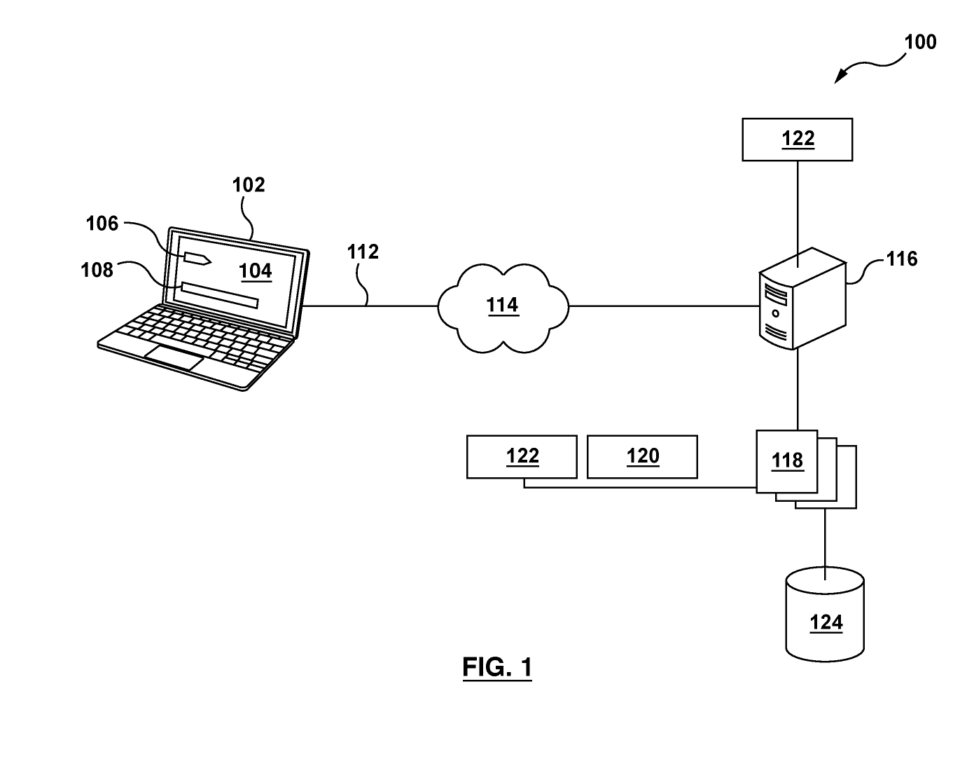

FIG. 1 depicts a schematic diagram of a system 100 implemented in accordance with an embodiment of the present technology. It is to be expressly understood that the system 100 is depicted as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to system 100 may also be described below.

This is done merely as an aid to understanding, and, again, not to define the scope or set forth the bounds of the present technology. These modifications are not an exhaustive list, and, as a person skilled in the art would understand, other modifications are likely possible. Further, where no examples of modifications have been set forth, it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to receive search queries and to conduct searches according to these queries, and to process search queries in accordance with non-limiting embodiments of the present technology. Thus, any system capable of processing user search queries, can be adapted for implementing the embodiments of the present technology using the non-limiting embodiment of techniques presented in this description.

The system 100 comprises an electronic device 102. The electronic device 102 is typically associated with a user (not depicted) and, as such, can sometimes be referred to as a “client device” or a “user device”. It should be noted that the fact that the electronic device 102 is associated with the user does not need to suggest or imply any mode of operation—such as a need to log in, a need to be registered or the like.

The implementations of the electronic device 102 are not particularly limited, but as an example, the electronic device 102 may be implemented as a personal computer (desktops, laptops, netbooks, etc.), a wireless electronic device (a cell phone, a smartphone, a tablet and the like), as well as network equipment (a router, a switch, or a gateway). The general implementation of the electronic device 102 is known in the art and, as such, will not be described here at much length. Suffice it to say that the electronic device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over a communication network 114; and a processor coupled to the user input interface, the user output interface and the network communication interface, the processor being configured to execute various routines, including those described herein below. To that end the processor may store or have access to computer readable commands which commands when executed, cause the processor to execute the various routines described herein.

The electronic device 102 comprises hardware and/or software and/or firmware (or a combination thereof), as is known in the art, to execute a search application 104. Generally speaking, the purpose of the search application 104 is to allow the user (not shown) to conduct a search, for example, a network search using a search engine.

How the search application 104 is implemented is not particularly limited. One of the examples of the search application 104 may include a user accessing a web site associated with a search engine to access the search application 104. For example, accessing the search application may be preformed by entering the URL (uniform resource locator) associated with the Yandex search engine, on www.yandex.ru, and it should be understood that accessing the search application 104 can be performed using any other suitable commercially available or proprietary search engine.

In other non-limiting embodiments of the present technology, the search application 104 can be a search application on a portable device (e.g., a wireless communication device). Particularly, in those cases where the electronic device 102 is a portable device, such as, e.g. Samsung™ Galaxy™ SIII, the electronic device can use a Yandex browser application. It should be expressly understood that any other commercially available or proprietary search application can be used for implementing non-limiting embodiments of the present technology.

Generally speaking, the search application 104 includes a query interface 106 and a search result interface 108. The main purpose of the query interface 106 is to allow a user (not shown) to enter his/her query or a “search request”. The main purpose of the search result interface 108 is to provide search results in response to the user query entered in the query interface 106. How exactly the search is conducted and how the providing of results is performed, will be described in greater detail below.

The electronic device 102 is coupled to the above-mentioned communication network 114 via a communication link 112. In some non-limiting embodiments of the present technology, the communication network 114 can be implemented as the Internet. In other implementations, the communication network 114 can be implemented alternatively as a wide area network or local area network, private network and the like.

How the communication link 112 is implemented is not particularly limited and will depend on how the electronic device 102 is implemented. Recalling that the electronic device 102 is implemented, in this example, as a laptop, the communication link 112 can be either wireless (such as the WirelessFidelity, or WiFi® for short, Bluetooth® or the like) or wired (such as an Ethernet based connection).

Also coupled to the communication network is a server 116. The server 116 may be implemented as a conventional computer server. In a non-limiting embodiment of the present technology, the server 116 may be implemented as a Dell™ PowerEdge™ Server running the Microsoft™ WindowsServer™ operating system. Needless to say, the server 116 may be implemented in any other suitable hardware and/or software and/or firmware or a combination thereof. In the depicted non-limiting embodiment of present technology, the server 116 is a single server. In alternative non-limiting embodiments of the present technology, the functionality of the server 116 may be distributed and may be implemented via multiple servers.

It should be expressly understood that implementations for the electronic device 102, the communication link 112 and the communication network 114 are provided for illustration purposes only. As such, those skilled in the art will easily appreciate other specific implementational details for the electronic device 102, the communication link 112 and the communication network 114. As such, by no means, examples provided herein above are meant to limit the scope of the present technology.

The electronic device 102 is configured to connect to the server 116 via the communication link 112. Generally, the communication link 112 allows the electronic device 102 to access the server 116 via the communication network 114. In some non-limiting embodiments of the present technology, the communication network 114 can be implemented as the Internet. In other embodiments of the present technology, the communication network 114 can be implemented differently, such as any wide-area communications network, local-area communications network, a private communications network and the like.

The general implementation of the server 116 is well known. However, briefly speaking, the server 116 comprises a communication interface (not depicted) structured and configured to communicate with various entities (such as the electronic device 102, for example, and other devices potentially coupled to the communication network 114) via the communication network 114. The server 116 further comprises at least one computer processor (not depicted) operationally connected with the communication interface and structured and configured to execute various processes to be described herein.

In some embodiments, the server 116 can be operated by the same entity that has provided the afore-described search application 104. In some embodiments, the server 116 can be operated by an entity different from the one who has provided the afore-described search application 104.

The server 116 is communicatively coupled to a search cluster 118. Even if the search cluster 118 is depicted as a server different from the server 116, in some other embodiments, functions of the search cluster 118 can be implemented by the server 116. In alternative non-limiting embodiments of the present technology, the functionality of the search cluster 118 may be distributed and may be implemented via multiple servers. In some embodiments of the present technology, the search cluster 118 is conducting a general search according to user queries entered into the query interface 106, and displaying search results to user via the search result interface 108. Within the non-limiting embodiments being presented herein, the search cluster 119 includes or somehow has access to a database 124.

Much akin to the server 116, the search cluster 119 can be implemented as a conventional computer server. In an example of an embodiment of the present technology, the search cluster 118 may be implemented as a Dell™ PowerEdge™ Server running the Microsoft™ WindowsServer™ operating system. Needless to say, the search cluster 118 may be implemented in any other suitable hardware and/or software and/or firmware or a combination thereof. In the depicted non-limiting embodiment of present technology, the search cluster 118 is a single server. In alternative non-limiting embodiments of the present technology, the functionality of the search cluster 118 may be distributed and may be implemented via multiple servers.

Within these embodiments of the present technology, the server 116 is configured to access, separately and independently, the search cluster 118 to conduct a search. In some embodiments of the present technology, the search cluster 118 may perform several types of searches, including, among other things, general search and vertical search. Thus, in some non-limiting embodiments of the present technology, the search cluster 118 includes (or otherwise accesses) a network search module 120 and a vertical search module 122. The network search module 120 is configured to perform general network searches, as is known in the art. Vertical search module 122 is configured to perform one or more vertical searches, for example, in image, music, video, news, maps verticals, and the like.

In other non-limiting embodiments of the present technology, the vertical search module 122 can be implemented as a portion of the search cluster 118. In these embodiments, the search cluster 118 is responsible for the coordination and conducting the general web-search and vertical search. In some embodiments of the present technology, the search cluster 118 can conduct a multi-level meta-search, while conducting the general web-search and the vertical search.

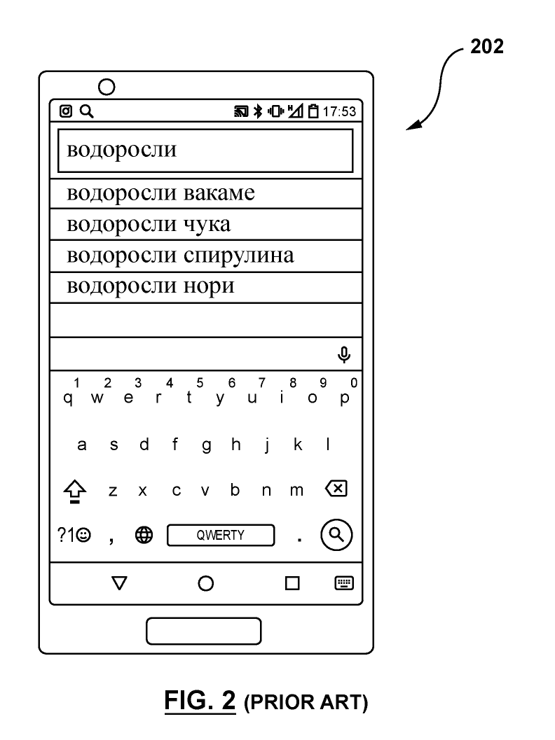

According to some non-limiting embodiments of the present technology, the server 116 is additionally configured to generate search query suggestions for the electronic device 102 for displaying thereof to the user while the user is forming a user query. As a person skilled in the art would understand, a search query suggestion to form a query is a function, whereby, in response to the user entering the search query, the search application 104 provides possible options for forming (i.e. competing) the search query. For example, if the user started to type “ [symbol] ” (“algae”), possible suggestions for the query can include “ [symbol] ” (“chuka”), “ [symbol] ” (“wakame”), “ [symbol] ” (“spirulina”), “ [symbol] ” (“nori”), as shown in FIG. 2, which, illustrates the search application generating search suggestions as is known in the prior art.

To implement the search query generation, the server 116 comprises or has access to a suggestion module 142. In the description to be presented herein below, the functionality of the suggestion module 142 will be described in the context of providing the user with the search query suggestions to form the query in accordance with non-limiting embodiments of the present technology.

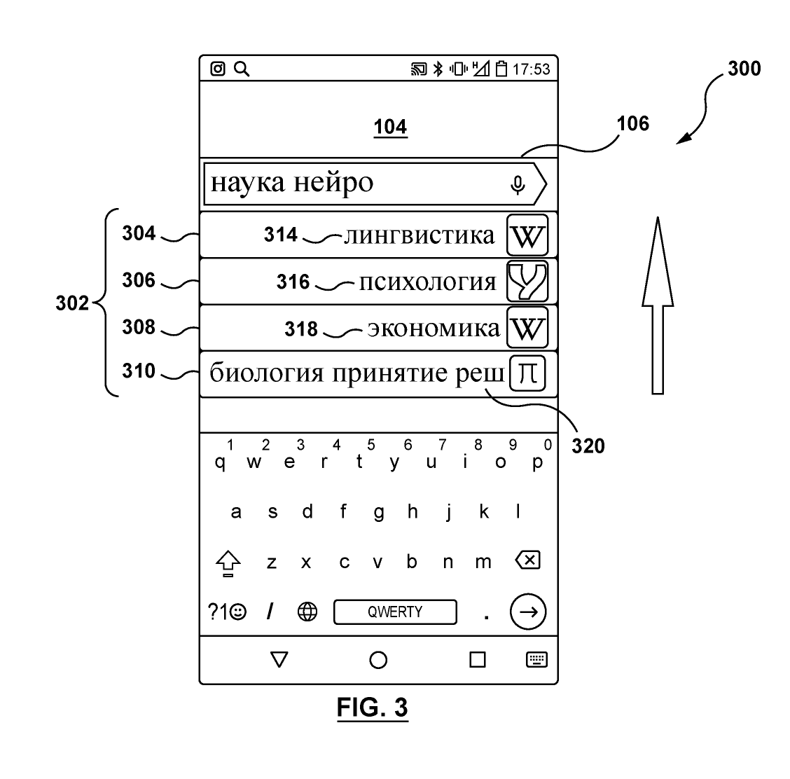

For a better understanding of the embodiments of the present technology, an example of a suggestion area will now be described in greater detail. FIG. 3 schematically shows the electronic device 102, similar to that which is shown in FIG. 1. The search application 104 includes a query interface 106 and a search result interface 108. In accordance with non-limiting embodiments of the present technology, there is also provided a suggestion area 202.

Generally speaking, the suggestion area 202 is an area of the search application 104 which is separated and is visually different from the search result interface 108. In some embodiments of the present technology, as shown in FIG. 3, the suggestion area 302 overlaps the search result interface 108 and is implemented as an area with suggestion elements associated with the query interface 106. In other non-limiting embodiments of the present technology, the suggestion area 302 can be located differently in relation to the query interface 106 and the search result interface 108, etc.

In other non-limiting embodiments of the present technology, the suggestion area 302 can replace a portion of the search application 104, as well as one or both of the query interface 106 and the search result interface 108.

In one embodiment of the present technology, the suggestion area 302 can have a transparent background. Alternatively or additionally, the suggestion area 302 can have a nontransparent background.

In one embodiment of the present technology, the suggestion area 302 comprises suggestion elements. The suggestion elements can include: a single suggestion element (e.g., one word), or a double suggestion element (for example, one word and numbers), or a triple suggestion element (for example, two words and numbers) or a multiple suggestion element (e.g., a phrase). Broadly speaking, the suggestion elements an include at least one of the following: parts of words, words, phrases, numbers, symbols, and/or a combination of some or all of the above.

In some embodiments of the present technology, the suggestion area 302 appears at the moment when the user performed a first input in the query interface 106 in a form of at least a portion of the search query, which is sufficient to start processing the user request, as will be described below. In other words, the suggestion area 302 may appear automatically without the user having to perform any additional actions. In another embodiment, it is possible that the suggestion area 302 appears in response to a user indication of her desire to use the search query suggestion functions. This is particularly useful but is not limited to those embodiments where, the first user input may be entered via voice control, as an example, the first user input may be a voice command.

In the illustrative embodiment shown in FIG. 3, a screen shot 400 depicts the search application 104 with the query interface 106 and the search result interface 108, the application includes the suggestion area 302 having four suggestion lines, and each suggestion line comprises a respective suggestion element: a first suggestion line 304 includes a first suggestion element 314, a second suggestion line 306 includes a second suggestion element 316, a third suggestion line 308 includes a third suggestion element 318, and a fourth suggestion line 310 includes a fourth suggestion element 320.

It should be expressly understood that the number of suggestion lines and suggestion elements in the suggestion area 302 is not particularly limited. For example, in some embodiments of the present technology, the suggestion area 302 can have only one suggestion line including one suggestion item. In other non-limiting embodiments of the present technology, the suggestion area 302 may have at least two suggestion lines containing two suggestion items. Alternatively or additionally, the number of the suggestion lines having the suggestion elements in suggestion area 302 can be dynamic. In other words, when the suggestion module 142 generates additional suggestion options while the user is forming the search query, the number of the suggestion lines having the suggestion elements in the suggestion area 302 may be dynamically increased.

For illustrative purposes, it is assumed that the user is interested in information about neuroscience. Therefore, the user entered the first input using a keyboard (such as but not limited to, a virtual keyboard) by inputting a first portion of the query “ [symbol] [symbol] ” (“neuro science ”) in the query interface 106.

In accordance with embodiments of the present technology, as will be described in greater detail below, the server 116 is configured to initiate displaying the suggestion area 302 by the search application 104 installed on a mobile user device (as an example). In accordance with non-limiting embodiments of the present technology and with reference to screenshots 300-301 (as depicted in FIG. 3), a portion of the process of creation the first suggestion element 314, the second suggestion element 316, the third suggestion element 318 and the fourth suggestion element 320 will now be described.

The server 116 is configured to trigger the search application 104 to display a generated suggestion to form a query in the suggestion line. In other words, each suggestion element—the first suggestion element 314, the second suggestion element 316, the third suggestion element 318 and the fourth suggestion element 320—includes the generated search query suggestion to potentially allow the user to form the completed query (that includes the partially entered search query and the search query suggestion, as a completion thereof). In a non-limiting embodiment of the present technology, the suggestion line includes at least one suggestion element representing at least a portion of the suggestion for the search query, and at least a portion of displaying the most appropriate response to the search query suggestion, together forming the search query.

In the above example, on the screenshot 300 in FIG. 3, non-limiting embodiments of the generated search query suggestion to form the query and the query response line can include the following.

The first suggestion line 304 may contain the following: “ [symbol] ” (“linguistics”). In this example, “ [symbol] ” is a suggestion element 314, which is a portion of the first suggestion line 304 generated as a suggestion to form the search query. In this embodiment, to save the screen space of the mobile user device, there are shown the suggestions being an addition to the already entered portion of the search query without repeating that portion of the search query.

The second suggestion line 306 may contain the following: “ [symbol] ” (“psychology”). In this example, “ [symbol] ” is a suggestion element 316, which is a portion of the second suggestion line 306 generated as a suggestion to form the search query.

The third suggestion line 308 may contain the following: “ [symbol] ” (“economics”). In this example, “ [symbol] ” is a suggestion element 318, which is a portion of the third suggestion line 308 generated as a suggestion to form the search query.

Finally, the fourth suggestion line 310 may contain the following: “ [symbol] [symbol] [symbol] ” (“biology of decision making”). In this example, “ [symbol] [symbol] [symbol] ” is a suggestion element 320, which is a portion of the fourth suggestion line 310 generated as a suggestion to form the search query.

Other embodiments are of course possible. The first suggestion line 304 may contain the following: “ [symbol] [symbol] ” (“linguistics . . . Wiki”). In this example, “ [symbol] ” is a suggestion element 314 being a portion of the first suggestion line 304 generated as a suggestion to form the search query, and “ [symbol] ” is a portion of the first suggestion line 304 generated for displaying a portion of the most suitable response to the suggestion to form the search query. FIG. 3, as the most suitable response to the suggestion, shows a link to a web-resource in a form of an icon, illustrating the “Wikipedia” web-resource. As persons skilled in the art would understand, there are other ways of displaying a link to a web-resource being the most suitable response to the suggestion.

The second suggestion line 306 may contain the following: “ [symbol] [symbol] [symbol] ” (“psychology . . . textbook”). In this example, “ [symbol] ” is a suggestion element 316 being a portion of the second suggestion line 306 generated as a suggestion to form the query, and “textbook” is a portion of the second suggestion line 306 generated for displaying a portion of the most suitable response to the suggestion to form the search query. FIG. 3, as the most suitable response to the suggestion, shows a link to a web-resource in a form of an icon, illustrating the web-resource including a relevant textbook.

The third suggestion line 308 may contain the following: “ [symbol] [symbol] ” (“economics . . . Wiki”). In this example, “ [symbol] ” is a suggestion element 318 being a portion of the third suggestion line 308 generated as a suggestion to form the search query, and “ [symbol] ” is a portion of the third suggestion line 308 generated for displaying a portion of the most suitable response to the suggestion to form the query. FIG. 3, as the most suitable response to the suggestion, shows a link to a web-resource in a form of an icon, illustrating the “Wikipedia” web-resource.

Finally, the fourth suggestion line 310 may contain the following: “ [symbol] [symbol] [symbol] [symbol] ” (“biology of decision making . . . PostNauka”). In this example, “ [symbol] [symbol] [symbol] ” is a suggestion element 320 being a portion of the fourth suggestion line 310 generated as a suggestion to form the search query, and “ [symbol] ” is a portion of the fourth suggestion line 310 generated as a portion for displaying the most suitable response to the suggestion to form the query. FIG. 3, as the most suitable response to the suggestion, shows a link to a web-resource in a form of an icon, illustrating the “ [symbol] ” web-resource.

In non-limiting embodiments of the present technology, a portion of the most suitable response to the suggestion to form the search query can be represented in the form of an icon retrieved from the web-resource that is the most suitable response to the suggestion to form the query; in the form of a link leading to a web-site page being the most suitable response to the suggestion to form the query, etc. Persons skilled in the art would also understand the benefits of other ways of presentation the most suitable response to the suggestion to form the query.

How the server 116 generates the above-mentioned suggestion examples while forming the search query and the most suitable response to the suggestion to form the search query will now be described.

When the user enters a portion of the search query into the query interface 106, the server 116 is configured to receive indications of the so-entered portion of the search request via the communication link 112 and to send the portion of the search query to the suggestion module 142. The suggestion module 142 is configured to generate one or more search query suggestions while forming the search query and the corresponding the most suitable responses.

In one non-limiting embodiment of the present technology, the suggestion module 142 may access to the aforementioned vertical search module 123. In some embodiments, the suggestion module 142 can access the entire set of verticals of the vertical search module 123. In other embodiments, the suggestion module 142 can access only a subset of verticals of the vertical search module 123. The subset of verticals of the vertical search module 123 may be defined based on a relevancy of the given subset of verticals of the vertical search module 123 to the given portion of the search query.

In this example, the suggestion module 142 may analyze the portion of the search query, namely, in this example, “ [symbol] [symbol] ”. Based on this analysis it is possible to determine that the most relevant vertical search will be conducted by a service dedicated to searching information on specific topics, for example, scientific information, which allows to show not only a response to the user query, but also a set of informational snippets on the topic.

Within the description presented herein, the detailed description of the vertical search modules and the corresponding generation of the suggestions to form the search query are omitted because the services used by the verticals of the vertical search module, are widely used and well known to those skilled in the art. However, it should be noted that the suggestion module 142 may have access to one of the many search verticals of the vertical search module 123 or to the entire set of the search verticals of the vertical search module 123.

Then, at least partially, based on the selected modules from a plurality of verticals of the vertical search module 123 (in particular, based on the information available in the selected vertical modules of the plurality of the vertical search modules 123), the suggestion module 142 generates the suggestions to form the search queries.

How exactly the suggestion module 142 generates the suggestions to form the search query is not particularly limited, and the process may include one or more of the following criteria: statistical popularity of the given term to form a search query based on a portion of the search query; the popularity of the given term to form a search query based on the search query for a particular user; how often a particular portion of the search query is used with the defining terms by other users (“image”, “video”, “weather”, etc.); and other additional information.

Additional information in a form of a dynamic parameter can also be (e.g., time of day, day of week, month of the year, upcoming holidays, etc.). The dynamic parameter is used to indicate a search parameter which is not explicitly included in the search query and may change in time.

For example, in the above example of the third suggestion line 208, a year can be used to specify “ [symbol] ” to “ [symbol] 2017”, given the fact that the search query was input in 2017. In other embodiments, if the search query was input in 2016, the suggestion module 142 would define and specify the suggestion to make a search query “ [symbol] 2016”.

Within the existing search applications 104, the query interface 106 is implemented as an “Omnibox” that includes a functionality of the input field for entering the URL and the input field for entering the search queries to the search engine. In other words, within the known techniques of the prior art, the user can use the query interface 106 to enter either the search query or the URL. Thus, the suggestion area 202 to form the search query may display to the user: suggestions in the form of a list of web-resources associated with at least a portion of the URL entered in the query interface 106, or suggestions in the form of a list of the parts of words, entire words, phrases, numbers, or combinations thereof, in response to at least the first user input entered in the query interface 106.

In the present description, the query interface 106 can be thought of as a “query field” and, as it was previously described above, the query interface 106 is an input field where the user can enter at least the first input to form the search query. Hence, in accordance with embodiments of the present technology, the term “query interface” will be referred to herein below, from time to time, as a “query field”. Moreover, in the present description “user search query” can also be thought of as a “user query”, and the term “user input” can be thought as a “user input”.

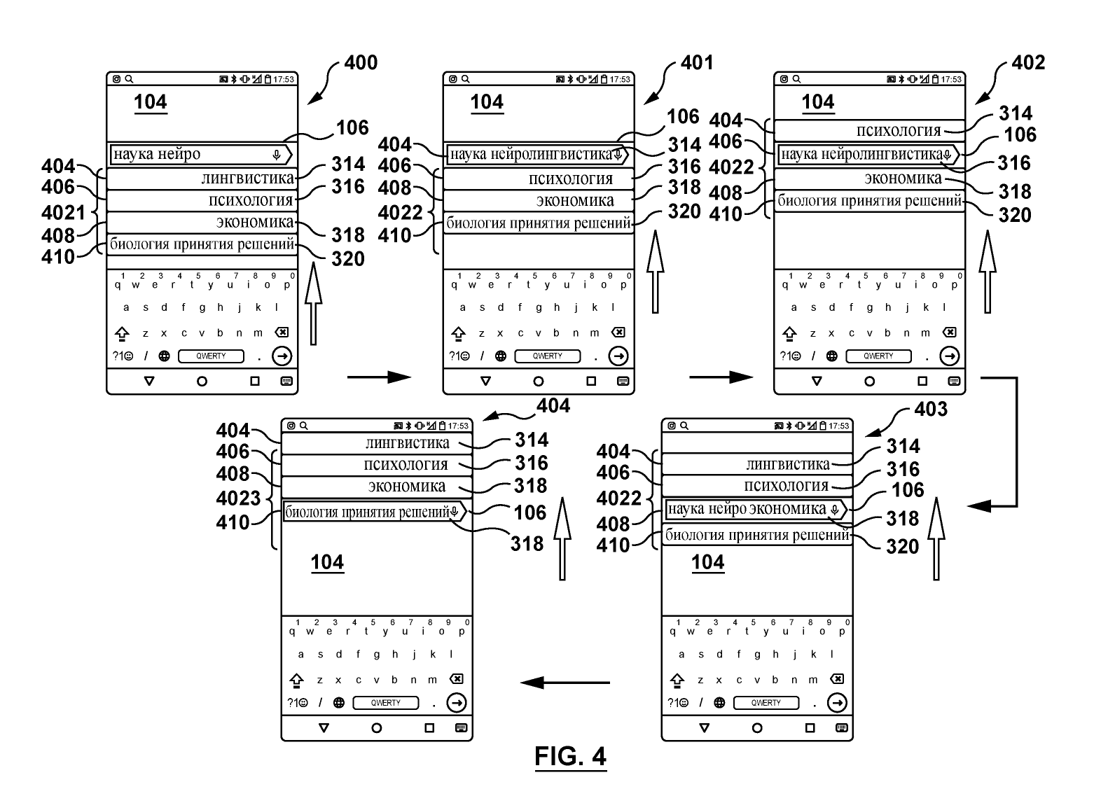

FIG. 4 schematically shows screenshot 400-404 depicting the suggestion area 402 during the various steps of the forming of the user query according to one non-limiting embodiment of the present technology.

FIG. 4 depicts a screenshot 400 with the suggestion area 4021 presented at a moment when the user has entered the first user input in the query field provided by the query interface 106. The first user input in the query interface 106 shows a portion of the search query “ [symbol] [symbol] ”. Thus, the suggestion area 402 appears as a drop-down list containing the first suggestion element 314 “ [symbol] ”, the second suggestion element 316 “ [symbol] ”, the third suggestion element 318 “ [symbol] ”, the fourth suggestion element 320 “ [symbol] [symbol] [symbol] ”, as described in relation to FIG. 3.

FIG. 4 depicts a screenshot 401 with the suggestion area 4022 presented at a moment when the user has entered the second user input associated with the suggestion area. The second user input associated with the suggestion area may be based on a mouse control, keyboard control, gesture control, touch control, voice control, etc. For example, the user may use the touch control to change a viewport of the suggestion area, for example, to scroll through the suggestion area. In the drawings, particularly, in FIG. 4 on screenshots 401-403, the direction of moving the suggestion area 4022 is depicted with a thick arrow showing the direction of the finger movement while using the touch screen. As can be appreciated form the screenshots 401-403, the second user input initiates the movement of the suggestion area 4022 relative to the query interface 106 so that the suggestion elements 314-320 in the suggestion area 4022 are sequentially aligned with the portion of the search query in the query interface 106, the portion having been entered by the user with the first user input. Thus, the user can observe how the suggestion area 4022 is moving relative to the query interface 106, or, in other words, how it passes through the query interface 106. In response to the first user input in a form of the search query portion, the suggestion area 4021 appears, as shown on the screenshot 400 of FIG. 4.

Suggestions are sequentially added in the query interface 106 to the entered portion of the user query as follows:

first, in the query interface 106 appears the suggestion in a form of the first element 314 “ [symbol] ” aligned with the portion “ [symbol] [symbol] ” of a search query in the query interface 106 (FIG. 4, the screenshot 401); then,

the query interface 106 depicts the query prompt that appears in the form of a second element 316 as the term “ [symbol] ” aligned with the portion “ [symbol] [symbol] ” of the search query in the query interface 106, and at this point the suggestion in the form of a first element 314 “ [symbol] ” is presented above the query interface 106 (FIG. 4, the screenshot 402); then,

the query interface 106 depicts the suggestion in the form of a third element 318 “ [symbol] ” aligned with the portion “ [symbol] [symbol] ” of the search query in the query interface 106, and the suggestion in the form of the first element 314 “ [symbol] ” and the suggestion in the form of the second element 316 “ [symbol] ” are represented above the query interface 106 and arranged in the same order in which they were presented in the drop-down list in the suggestion area, and in which they subsequently appeared in the query interface 106 (FIG. 4, the 403 screen); then

the query interface 106 may be augmented with the suggestion in the form of a fourth element 320 “ [symbol] [symbol] [symbol] ” aligned with the portion “ [symbol] [symbol] ” of the search query in the query interface 106, and the suggestion in the form of the first element 314 “ [symbol] ”, and the suggestion in the form of the second element 316 “ [symbol] ”, and the suggestion in the form of the third element 318 “ [symbol] ” are be represented above the query interface 106 and arranged in the same order in which they were presented in the drop-down list in the suggestion area, and in which they subsequently appeared in the query interface 106.

The user may review the suggestions aligned with the entered portion of the search query, as they are sequentially aligning with the portion of the query in the query field.

In other words, in the present embodiment, the suggestion area moves upwards, simulating the rotation of a wheel, as the user performs the scrolling of the suggestion area 402. In this embodiment of the present technology, the suggestion elements 314-318 are moving from the bottom towards the query interface 106, are sequentially aligned with the portion of the search query in the query interface 106, and then continue moving upwards from the query field, as shown in FIG. 4 on the screenshots 400-404. More specifically, the scrollable suggestion area is implemented as a closed loop, in which the suggestion elements cyclically repeat if the user continues to scroll the suggestion area. Thus, the user can also return to the previously viewed suggestion, if (s)he continues scrolling the suggestion area in the same direction, i.e. without changing the direction of scrolling the suggestion area. However, the user can return to the previously viewed suggestion by scrolling the suggestion area backwards. It should be understood, that, without departing from the scope of the present technology and the appended claims, there are other embodiments wherein the scrollable suggestion area is not a closed loop, but the advantages of the present technology are still at least partially presented. Thus, the user can view all unused suggestions, and they will be located above the query interface 106.

For example, in FIG. 4 on the screenshot 403 the suggestion in the form of the first element 314 “ [symbol] ” and the suggestion in the form of the second element 316 “ [symbol] ” are located above the query interface 106, i.e. moved as a result of scrolling the suggestion area 4022. Thus, the user can view the suggestions divided into those which the user has considered inappropriate to form the search query—they will be shown above the query interface 106, —and those which have yet to be considered—they will be shown underneath the query interface 106. This provides the user with an additional advantage, i.e., the ability to sort out the unsuitable suggestions and to return to them in the process of forming the query, while distinguishing the ones that have already been considered by the user unsuitable for forming the query and the ones that have not been reviewed by the user. Thus, the user may scroll the suggestion area backwards to return the already viewed suggestion back into the query interface 106 to form the suggested search query, and the user may view and check all the search query suggestions while scrolling.

The user can use voice control, for example, dictate the selected suggestion, and then the suggestion area will move till the moment when the selected suggestion will be aligned with the entered portion of the user query in the query field.

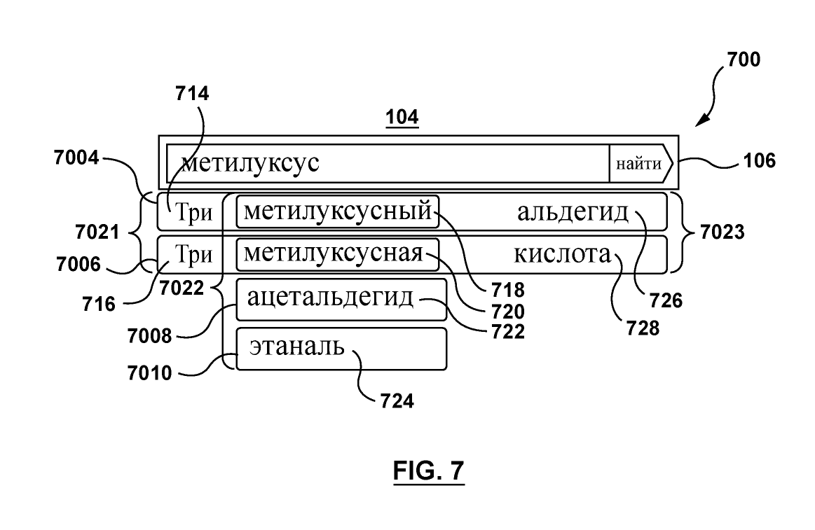

In accordance with the non-limiting embodiments of the present technology, it is possible to display more suggestions (using the same available real estate of the screen) compared to the prior art solutions. The suggestion elements in the suggestion area can be provided not only for the current partially entered search query, but also for all preceding partially entered versions of the currently entered partially search query. This will be described further in more detail in the present description with reference to FIG. 7.

In the present embodiment, it is assumed that the described movement of the suggestions in the suggestion area may continue until the user enters the third user input. However, if the suggestions are not moving and the user-selected suggestion element, for example, the suggestion element 320 stays in the query interface 106 for a predetermined period of time, the query is considered complete and is to be sent to the server. Thus, embodiments of the present technology contemplate forming of the search query using the search query suggestion currently being associated (i.e. aligned) with the partially entered search query without receiving an express command from the user.

FIG. 4 depicts a screenshot 404 with the suggestion area 4022 presented at the moment when the user has entered the third user input associated with the suggestion area to form the search query. The third user input associated with the suggestion area may be based on a mouse control, keyboard control, gesture control, touch control, voice control, etc. The third user input initiates the sending of the completed search query to the server when the selected item from the suggestion elements 314-320 is aligned with the entered portion of the query in the query interface 106. For example, the user may select the suggestion, may dictate the selected suggestion being, for example, the first element 314 “ [symbol] ”, resulting in aligning this suggestion with a portion of the search query in the query field. The user can then enter the third user input, for example, can pronounce a voice command, in particular, “search”, meaning the completion of the request and initiating the sending of the query to the server.

Thus, using the third user input, the user can form the completed search query. In addition, the user query can be considered complete, if the user entering the second user input puts the suggestion in the query field using, for example, a voice command, or using the scrolling option of the suggestion area, and then the user performs no action on the suggestion area and/or the query field within a predetermined time period. Reaching the predetermined period may trigger the electronic device 102 to execute sending to the server the completed search query formed using the search query suggestion, which is aligned with the partially entered portion of the search query. In addition, if the suggestion bar is displaying not only the suggestion element but also the most suitable answer to the suggestion, the user can quickly select the most suitable response to the suggestion and the query can also be considered complete.

Thus, the completion of the user query can be carried out without the third user input. In addition, the completion of the user query can be carried out by the second user input. However, the second user input does not necessarily mean the completion of the user query.

In some embodiments of the method, the forming of the search query includes repeating the steps of receiving the first and the second user inputs. In other words, when the user enters the first user input, he will be shown the suggestion area, and the user can scroll the suggestion area until the selected suggestion element is aligned with the entered portion of the search query in the query field. Then, the user may not enter the third input and may not wait for the reaching the predetermined period of time, and may continue to work with the entered portion of the search query, for example, to edit the search query.

In some embodiments of the method, the user can stop formulating the search query if the most suitable response to the suggestion is displayed next to the suggestion element.

In one embodiment of the present technology, the suggestion portion matching the entered portion of the search query may have a different formatting for the user's convenience. Moreover, in the present embodiment, the suggestions are presented without any mentions or any other citations of the user query portion “ [symbol] [symbol] ” entered by the user.

Of course, the suggestions can also be presented with references or other citations of the user query portion which was entered by the user. In this case, the suggestion can be formulated, for example, as “ [symbol] [symbol] ”.

The suggestion area in the form of a feed list of suggestions can show more suggestions than displayed on a screen of the user electronic device. Due to the fact that the user can move the suggestion list, and when the at least one suggestion element, which was initially displayed, has disappeared from the screen as a result of moving the suggestion area, the suggestion area is dynamically updated and the user can see at least one new suggestion element.

Thus, when using the suggestion area, the user is required to perform a comparatively low number of actions: enter at least a portion of the query in the query field and scroll the suggestion area until the user-selected suggestion element is aligned with the entered portion of the query in the query field. Other actions, including the voice input, or pressing “find” button are optional.

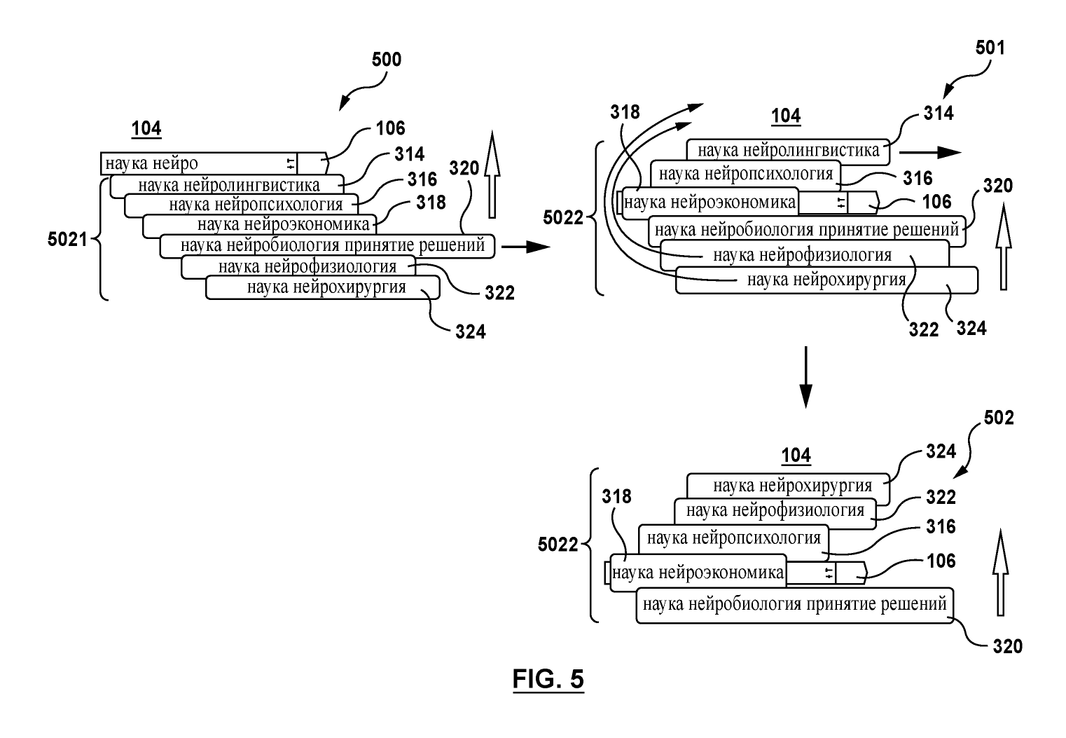

FIG. 5 schematically shows screenshots 500-503, which illustrate another non-limiting embodiment of the search application 104, wherein a suggestion area is shown during various steps of forming the search query.

FIG. 5 depicts the screenshot 500 with the suggestion area 5021 presented at the moment when the user has entered the first user input in the query field provided by the query interface 106. The first user input in the query interface 106 is a portion of the search query “ [symbol] [symbol] ”. Thus, the suggestion area 5021 is shown as a drop-down list containing the first suggestion element 314 “ [symbol] [symbol] ”, the second suggestion element 316 “ [symbol] [symbol] [symbol] [symbol] ” (“science pediatric neuropsychology”), the third suggestion element 318 “ [symbol] [symbol] ” (“science neuroeconomics”), the fourth suggestion element 320 “ [symbol] [symbol] [symbol] [symbol] ” (“science neurobiology of decision making”), in the same way as described in connection with FIG. 3. In this embodiment, for the purposes of illustration, there is also the fifth suggestion element 322 “ [symbol] [symbol] ” (“science neurophysiology”) and the sixth suggestion element 324 “ [symbol] [symbol] ” (“science neurosurgery”).

FIG. 5 depicts a screenshot 501 with the suggestion area 4022 presented at the moment when the user has entered the second user input associated with the suggestion area. The second user input associated with the suggestion area may be based on a mouse control, keyboard control, gesture control, touch control, voice control, etc. For example, the user can use a touch control to move the suggestion area. In the drawings, particularly, in FIG. 5 on screenshots 501-503, the direction of moving the suggestion area 5022 is depicted with an arrow showing the direction of the user finger movement while using the touch screen. On the screenshots 501-502 it is shown that the user can control the suggestion area and not only move the suggestion area by scrolling.

Particularly, in FIG. 5, on the screenshot 501 it is shown that the user can remove one of the suggestion elements from the suggestion area. On the screenshot 501 a black arrow shows the direction, in which the user “eliminates” the element 314 from the suggestion area. In the present embodiment, the user decides that the suggestion element 314 “ [symbol] [symbol] ” is not suitable to form the query and wants to remove this element from the suggestion area so it will stop taking the useful screen space and distracting the user's attention. The user can remove any suggestion element from the query field using, for example, touch control or any other type of control. On the screenshot 502 of the suggestion element 314 is already absent in the suggestion area.

The screenshot 501 is depicted at the same state as the illustration of FIG. 4. With reference to the screenshot 501, it can be appreciated that the second user input initiates the movement of the suggestion area 4022 relative to the query interface 106 so that the suggestion elements 314-320 in the suggestion area 4022 are subsequently aligned with the portion of the search query in the query interface 106, the portion having been entered by the user with the first user input. FIG. 5 does not illustrate in detail the movement of the suggestion area 5022 in relation to the query interface 106, as this movement is similar to the movement described in FIG. 4.

Thus, the user can observe how the suggestion area 4022 is moving relative to the query interface 106, or, in other words, how it passes through the query interface 106. The suggestions are sequentially added in the query interface 106 to the portion of the entered user query in accordance to FIG. 4. As can be appreciated from the screenshot 501, the query interface 106 has the suggestion in the form of the third element 318 “ [symbol] [symbol] ” aligned with the portion “ [symbol] [symbol] ” of the search query in the query interface 106, and the suggestion in the form of the first element 314 “ [symbol] [symbol] ” and the suggestion in the form of the second element 316 “ [symbol] [symbol] [symbol] ” is represented above the query interface 106 and arranged in the same order in which they were presented in the drop-down list in the suggestion area, and in which they had been sequentially displayed in the query interface 106. As was mentioned above, the user is desirous of removing the first suggestion element 314 “ [symbol] [symbol] ”, which is indicated by the black arrow next to the suggestion element 314 “ [symbol] [symbol] ”.

As can be further appreciated from FIG. 5 on the screenshot 501, the user can move the suggestion elements in the list from one line to another as the user sees fit. In the present example, the user decided that the fifth suggestion element 322, and the sixth suggestion element 324 are not suitable to form the query, for example, if they have little relevance to the topic, in which the user is interested, or if the user wants to go back to these suggestions later. To this end, the user selects the fifth suggestion element 322 and the sixth suggestion element 324, as it is indicated by the arrows in FIG. 5 on the screenshot 501. The user then moves them over the query interface 106 so that they remain in the portion of the query field, i.e. the user expanded the query field at the top end thereof. Particularly, while moving the suggestion elements it is possible to automatically form the suggestion lines for them, as shown in FIG. 5 on the screenshot 501. The suggestion elements can be moved in any place (line) of the suggestion area, for example, the user can place the element 322 between the suggestion elements 316 and 318, or the user can swap the fifth suggestion element 322 and the third suggestion element 318.

Additionally, if the user remembers the suitable suggestion, which is not currently displayed in the suggestion area, i.e. is absent among the suggestion elements, the user can add this suggestion, for example, via voice control. In this case, the suggestion area can be dynamically updated to add several suggestions in the suggestion area based on the user-added suggestions, including or alternatively based on the user's query history.

In addition, if the user has excluded any suggestion, then the suggestion area can be dynamically updated by adding or replacing some suggestions based on the user-excluded suggestion, including or alternatively based on the user's past search query history.

Moving the suggestion area 5022 can be implemented as an animation of moving the suggestion area 5022 along a circle with an intersection of the query interface 106, i.e. the suggestion area 5022 is passing through the query interface 106. In one embodiment in FIG. 5, the suggestion area 5022 visually imitates a three-dimensional/volumetric rotation of the wheel being performed at an angle to the vertical. Suggestion elements 5022 are moving upwards from the bottom to the query interface 106, sequentially aligning with the portion of the search query in the query interface 106 and continue moving upwards away from the query field. Naturally, moving of the suggestion area 5022 may also be implemented as an imitation of a three-dimensional (volumetric) moving along the surface of a closed circle or an opened circle. Other modifications of the suggestion area will be apparent to persons skilled in the art without departing from the scope of the present technology.

Thus, in this embodiment of the present technology, the user can see all the unused suggestions, including those that the user has removed, and they will be located, for example, over the query interface 106. Particularly, in FIG. 5 on the screenshot 502 the suggestion in the form of the second element 314 “ [symbol] [symbol] ” is located above the query interface 106, i.e. moved as a result of scrolling the suggestion area 4022.

The suggestion in the form of the fifth element 322 “ [symbol] [symbol] ” and the suggestion in the form of the sixth element 324 “ [symbol] [symbol] ” are located above the query interface 106, i.e. were moved as a result of the user's action. Thus, apart from the advantages described in connection with FIG. 4, there is also an additional advantage to the user. In other words, embodiments of the present technology provide the user with an enhanced ability to sort the suggestion elements in the suggestion area. This enhanced ability is due, sat least partially, to the ability to execute movement the suggestions relative to each other, changing in the order of the suggestions is provided. Typically in the prior art, the order of the suggestions is determined by the suggestion ranking performed by the search engine. When the user moves the suggestions in the suggestion area according to their preferences, the user thus modifies or forms such a suggestion area that can be stored in the user history and can influence the suggestion ranking and the suggestion generation for subsequent search queries from that user. Needles to say, the suggestion area can also be dynamically updated in response to the fact that the user modifies the entered portion of the search query.

In order to send the query to the server, the user may perform the third user input. In the present embodiment, the third user input may be a sensor touch on the suggestion element 318, or a sensor-touch of the “find” button. However, as it was already described with the reference to FIG. 4, the search query may be formed in the position of the suggestion area relative to the query interface 106, when the selected suggestion element is in the query field.

FIG. 5 depicts an embodiment in which the suggestion lines overlap. The suggestion lines may also be located one over another, as it is depicted in FIG. 4, or one next to another, if the suggestion area goes through the query interface 106, substantially horizontally, or while changing the suggestion area from the vertical moving to the horizontal one.

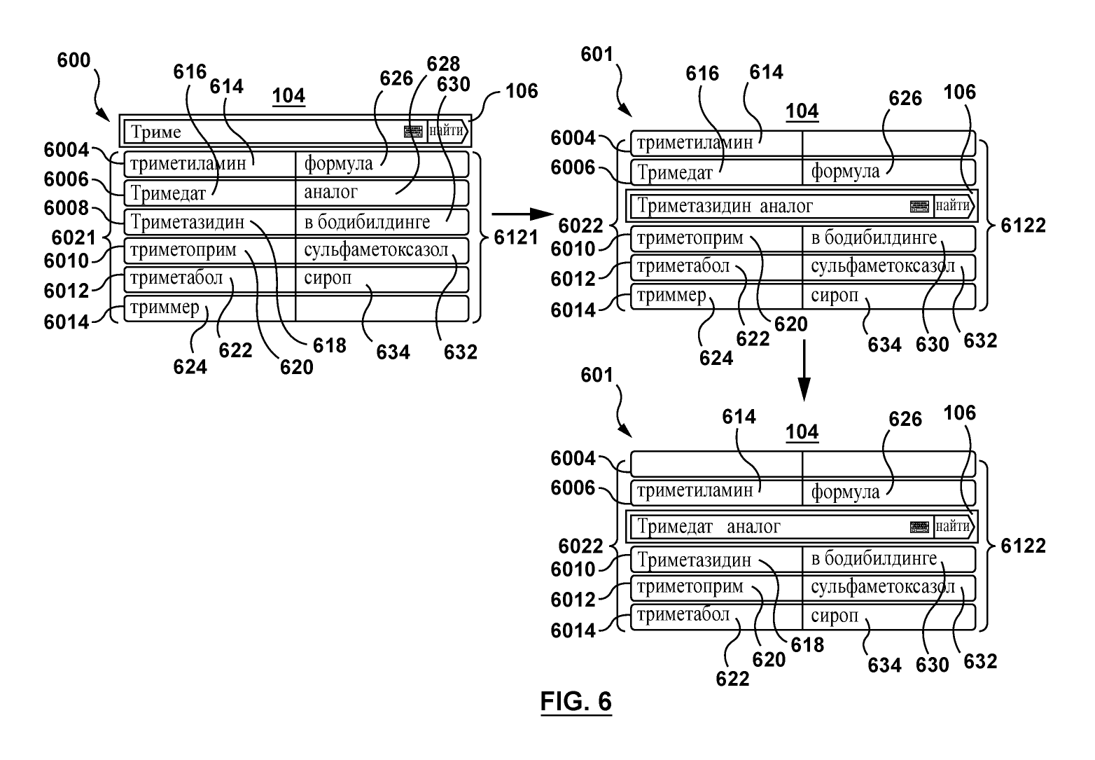

FIG. 6 schematically shows screenshots 600-602 depicting the search application 104 during the various steps of the forming the user query according to another non-limiting embodiment of the present technology.

FIG. 6 depicts a screenshot 600 with the suggestion area 6021 presented at the moment when the user has entered the first user input. In the query interface 106 the first portion of the query “ [symbol] ” is entered. In the depicted embodiment of the present technology, in addition to the suggestion area 6021 there is another suggestion area 6121.

The suggestion area 6021 has the first suggestion element 614 “ [symbol] ” (“trimethylamine”) in the first line 6004, the second suggestion element 616 “ [symbol] ” (“trimedat”) in the second line 6006, the third suggestion element 618 “ [symbol] ” (“trimetazidine”) in the third line 6008, the fourth suggestion element 620 “ [symbol] ” (“trimethoprim”) in the fourth line 6010, the fifth suggestion element 622 “ [symbol] ” (“trimetabol”) in the fifth line 6012 and the sixth suggestion element 624 “ [symbol] ” (“trimmer”) in the sixth line 6014. The suggestion area 6121 has the seventh suggestion element 626 “ [symbol] ” (“formula”) in the first line 6004, the eight suggestion element 628 “ [symbol] ” (“analogue”) in the second line 6006, the ninth suggestion element 630 “ [symbol] ” (“in body building”) in the third line 6008, the tenth suggestion element 632 “ [symbol] ” (“sulfamethoxazole”) in the fourth line 6010, the eleventh suggestion element 634 “ [symbol] ” (“syrup”) in the fifth line 6012 and the sixth line 2014 is left empty.

In this non-limiting embodiment, the second suggestion area 6121 is generated in accordance with one of the following: automatically, in response to a user action associated with the suggestion area 6021, in response to a user action associated with the input in the query interface 106, or depending on the settings of the search application 104.

For example, the user has entered the first user input in the query field in the form of the portion of the word “ [symbol] ”. In this case, in the first suggestion area 6021 several suggestions, which can be ranked by relevance, are shown to the user. The additional suggestion area 6121 contains suggestions being a continuation of the corresponding suggestions from the first suggestion area 6021. The first suggestion element 614 “ [symbol] ” (“trimethylamine”) in the first suggestion area 6021 and the first suggestion element “formula” in the second suggestion area 6022 are located in a single line 6004 and represent the most commonly searched phrase. This applies to all phrases formed by the suggestion elements, arranged in a single line. However, not all the suggestion elements will have this specified accordance. For example, the sixth suggestion element 624 is the word “ [symbol] ”. Firstly, the word “ [symbol] ” contains two letters “M”, while the entered portion “ [symbol] ” of the user's query contains only one letter “M”. In this case, it is assumed that the user made a typo by entering “ [symbol] ”, and the user is offered with another suggestion element 624 “ [symbol] ” where the supposed typo is corrected. Secondly, in the second suggestion area 6121 the sixth line 6014 corresponding to the suggestion element 624 in the first suggestion area 6021 is empty. The sixth suggestion element 624 “ [symbol] ” is merely the version of this suggestion for the case of a possible user's typo, and thus may not be a suitable version of the suggestion, there is no need to add another suggestion element, corresponding to the suggestion element 624, to the suggestion line in the second suggestion area 6022. In addition, the empty line against the supposed suggestion element helps the user to pay attention to this suggestion element 624. If the user chooses it by, for example, selecting, then both areas can be dynamically updated in response to this action.

The user can scroll the first suggestion area 6021 and the second suggestion area 6121 synchronously and independently from each other to align one desired suggestion element with another desired suggestion element in a single line, in particular, in the query interface 106.

Consider the case when the user wants to search, for example, for all the analogues of the trimetazidine. To do so, the user enters the second user input associated with the suggestion area by scrolling the first suggestion area 6022 and the second suggestion area 6122 synchronously until they will be aligned with the query interface 106. FIG. 6, on the screenshot 601 are shown the suggestion area 6022 and the suggestion area 6122 at the stop of the second user input. This initiates the positioning of the second suggestion element 620 “ [symbol] ” from the first suggestion area 6022 and the eighth suggestion element 628 “ [symbol] ” of a second suggestion area 6122 in query interface 106 (FIG. 6, the screenshot 601).

Further, the user can change his mind and want to see the formula of the “ [symbol] ” first. To this end, the user scrolls the suggestion area 6022 back to align the third suggestion element 618 “ [symbol] ” with the query interface 106, and then scrolls the area 6122 until the seventh suggestion element 628 “ [symbol] ” is aligned with the suggestion element 618 “ [symbol] ” in the query interface 106 (FIG. 6, the screenshot 602). In particular, the user can remove the sixth suggestion element 624 “ [symbol] ” as unsuitable, and it will be absent in FIG. 6, the screenshot 602. If the user selects the sixth suggestion element 624 “ [symbol] ”, all the suggestion areas may be dynamically updated taking into account the search term.

As such, the user can check any combination of the suggestion elements displayed in the suggestion areas. In particular, the user not only can scroll the first suggestion area 6022 and the second suggestion area 6122 relative to each other, but also move the suggestion elements 614-334 in the suggestion lines 6004-6014 relative to each other; transfer them from one suggestion area to another, for example, from the first suggestion area 6022 to the second suggestion area 6122. In addition, the user can check all possible combinations of the suggestion elements 614-334 and remove the suggestion elements 614-334 from the suggestion areas.

Needless to say, when the suggestion elements 614-334 from two suggestion areas 6022 and 6122 are in the same line, they do not need to form phrases, for example, they can be a set of keywords. The described combination is possible and might be very useful for conducting professional searches on any subject, for example, search on chemical topics and any topics, in which the offered suggestion elements may be modified within the entered portion of the query.

If originally the user was provided with only one (first) suggestion area 6021, the user can initiate the displaying the second suggestion area 6121. If originally the user was provided with the first suggestion area 6021 and the second suggestion area 6121, the user may selectively control any of these areas (in particular, remove any of these areas, to combine the first suggestion area 6021 with the second suggestion area 6122, etc.). The user can perform the above-mentioned actions on the suggestion areas at the step of the first user input or the second user input. The user can perform the above-mentioned actions on the suggestion areas, for example, using mouse control, keyboard control, touch control, voice control, gesture control, or any suitable way known to the person skilled in the art.

FIG. 7 depicts the screenshot 700, presenting three suggestion areas for the portion of the search query. For example, the user desires to search for or only to see suggestion to the search query “ [symbol] ”. In this case, the user can be provided with three areas of tips: the first suggestion area 7021, including the first element 714 “ [symbol] ”, and the second suggestion element 716 “ [symbol] ” (in this case, the first and second suggestion elements are the same to make it easy to scroll through all three areas simultaneously); the second suggestion area 7022, which includes the third suggestion element 718 “ [symbol] ” and the fourth suggestion element 720 “ [symbol] ” (in this case, the third and fourth suggestion elements are also the same, to make it easy to scroll through all three areas synchronously), the fifth suggestion element 722 “ [symbol] ” and the sixth suggestion element 724 “ [symbol] ”; the third suggestion area 7023, including the seventh suggestion element 726 “ [symbol] ” and the eighth suggestion element 728 “ [symbol] ”. The suggestion area 7021 has two lines, and the suggestion line 7004 includes the first suggestion element 714, the third suggestion element 718, the seventh suggestion element 726; the second suggestion line 7006 includes the second suggestion element 716, the fourth suggestion element 720 and the eighth suggestion element 728, and the eighth suggestion line 7008 includes the fifth suggestion element 722, and the fourth suggestion line 7010 includes the sixth suggestion element 724.

The fifth suggestion element 722 “ [symbol] ” and the sixth suggestion element 724 “ [symbol] ” do not contain even a portion of the entered search query, but are synonyms, i.e. other/alternative names of the substance, in which the user is probably interested, and they are provided as a suggestion for the entered portion of the search query or as a synonym for the combination of the first line 7004 formed by the first suggestion element 714 “ [symbol] ”, the third suggestion element 718 “ [symbol] ” and the seventh suggestion element 726 “ [symbol] ”. The screenshot 700 explicitly shows that the first suggestion element 714 “ [symbol] ”, and the second suggestion element 716 “ [symbol] ” are the suggestion for the beginning of the word, the portion of which is the entered portion of the search query. Thus, three query fields may include suggestions to form the beginning of the query, which is very convenient for conducting searches on various scientific topics. Sometimes the user may forget the correct prefix, a compound word for a searched term, or even the first letters of a search term, etc. In this case, another query field may be shown, in this embodiment, the third query field to display to the user the suggestions to form the query.

With reference to FIG. 7, one can appreciate that the user can modify and manage all the three suggestion areas in the same way that was described with reference to FIGS. 5 and 6, i.e. change the location of the suggestion elements 714-728 within all three areas, within two user-selected areas or within only one area, as well as remove the suggestion elements selected from the suggestion elements 714-728.

In the suggestion area 7021, in the suggestion area 7023 the suggestion line 7008 and the suggestion line 7010 are empty. Thus, if the suggestion element is missing in the suggestion area, this suggestion element can also be referred to as an empty search query suggestion.

The suggestion area 7021, the suggestion area 7022 and the suggestion area 7023 can be moved synchronously so that the suggestion elements 714, 716, 726 remain in the suggestion line 7004, the suggestion elements 716, 720, 728 remain in the suggestion line 7006, the suggestion element 722 remains in the suggestion line 7008, and the suggestion element remains in line 7010. Additionally, the suggestion areas 7021-7023 can be moved so that each suggestion area 7021-7023 is moved relative to each other functioning as a code lock.

Thank to these three scrollable areas there is provided a significant expansion in the number of suggestions and in the variety of suggestions to form the query, an ability to align or otherwise combine them together, and thus reduce the number of management actions using the suggestion area: touch control, gesture control, mouse control or keyboard control.

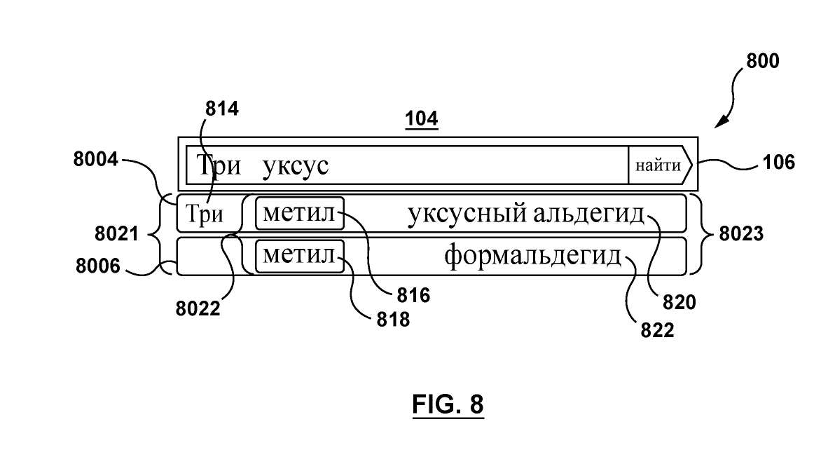

FIG. 8 shows the screenshot 800, presenting three suggestion areas for the portion of the search query. For example, the user wants to formulate a query using keywords, of which (s)he remembers only the prefix “ [symbol] ” the first searched keyword and the second compound word “ [symbol] ” of the searched key word. Sometimes the user needs to see the suggestions on the searched term, for example, to refresh his/her memory of the correct term, or additionally, to look at other possible wordings of this term. In this case, the user can also be provided with three suggestion areas: the first suggestion area 8021, including the first suggestion element 814 “ [symbol] ”; the second suggestion area 8022, including the second suggestion element 816 “ [symbol] ” and the third suggestion element 818 “ [symbol] ”, the third suggestion area 8023, including the fourth suggestion element 820 “ [symbol] [symbol] ” and the fifth suggestion element 822 “ [symbol] ”. The suggestion area 8021 has two lines, and the suggestion line 8004 includes the first suggestion element 814, the second suggestion element 816 and the fourth suggestion element 820; the second suggestion line 8006 includes the third suggestion element 818 and the fifth suggestion element 822.

The second suggestion element 816 “ [symbol] ” in this case is the middle portion of the search query, which the user, for example, have forgotten, and therefore entered the portion of the query without this part.

The third suggestion element 818 “ [symbol] ” in this case is an alternative or a synonym for the entered portion of the search query.

All the suggestion elements in the suggestion area do not necessary need to be different, some may repeat depending on the entered search terms.

With reference to FIG. 8, screenshot 800, one can appreciate that the user can modify and manage all the three suggestion areas in the same way as was described with reference to FIGS. 5, 6 and 7, i.e. change the location of the suggestion elements 814-822 within all three areas, within two user-selected areas or within only one area, as well as remove the suggestion elements selected from the suggestion elements 714-728.

The suggestion area 8021, the suggestion area 8022 and the suggestion area 8023 can be moved synchronously so that the suggestion elements 814, 816, 820 remain in the suggestion line 8004, and the suggestion elements 818, 822 remain in the suggestion line 8006. Additionally, the suggestion areas 8021-8023 can be moved so that each suggestion area 8021-8023 is moved relative to each other functioning as a code lock.

A larger number of suggestion areas is also possible without departing from the scope of the present technology. All actions performed on two displayed suggestion areas can be applied also to three or more suggestion areas.

Within the above-mentioned embodiments of the present technology, other locations of the suggestion area relative to the query interface 106 are also possible, as well as any other moving of the suggestion area relative to the query interface 106.

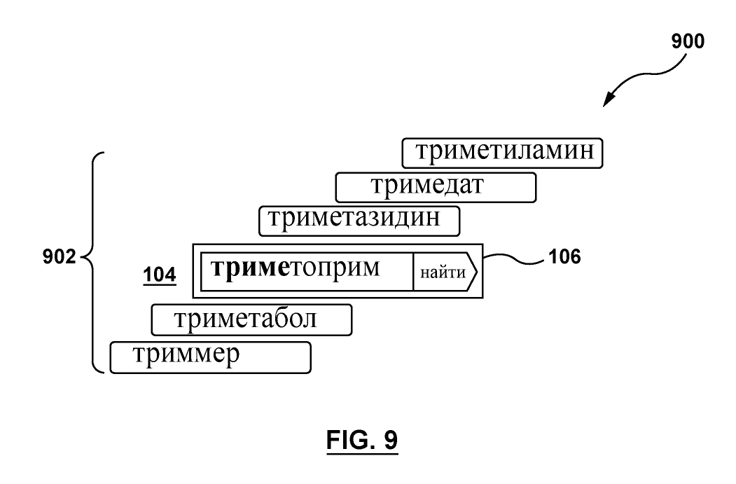

In one non-limiting embodiment of the present technology, as shown in FIG. 9, there is depicted a search application 104 with a suggestion area 902. In this embodiment, the suggestion area 902 is a feed list of suggestion elements (without any reference numbers), which, in response to the second user input, starts moving from the lower left corner up to the query interface 106 and then continues to move up from the query interface 106 and to the right in the upper right corner. While moving the suggestion elements from the suggestion area 902 are sequentially aligned with the portion of the search query in the query interface 106.

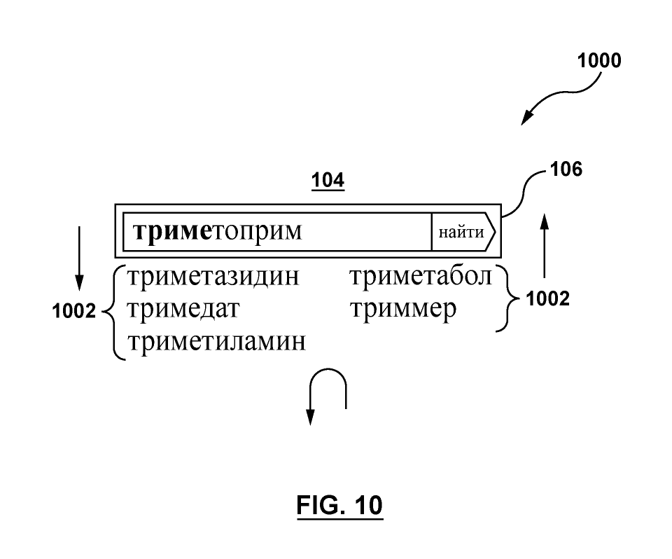

In one non-limiting embodiment of the present technology, as shown in FIG. 10, there is depicted a search application 104 with a suggestion area 1002. In this embodiment, the suggestion area 1002 is a feed list of the suggestion elements, which, in response to the second user input, starts moving vertically upwards to the query interface 106, then the suggestion elements are sequentially aligned with the portion of the search query in the query interface 106, and then a list of suggestion elements is moving vertically downward from the query interface 106. The movement directions of the suggestion area are shown using arrows.

The movement directions of the suggestion area relative to the query field may be different and will depend on the size and orientation of the screen of the user electronic device. In particular, the movement directions of the suggestion area relative to the query field may be horizontal, and in this case the suggestion elements will be located essentially horizontally next to one another.

The suggestion elements should not necessarily be separated from one another by any lines, as shown in most of the drawings.

In one embodiment of the present technology, the speed at which the suggestion area moves, may be reduced after the user-selected suggestion element reaches the query interface 106.

Suggestion elements 214 in the query interface 106 can be located in accordance to one of the following: next to one another, one below another, overlapping, or any other positioning that can be understood by a person skilled in the art.

Given the architecture described with reference to FIG. 1, and the example provided in FIG. 4, it is possible to execute a method of forming a search query. A method of forming a search query on an electronic device can be successfully executed on a server 116. In this case, the server includes a computer usable information storage medium storing computer instructions that, when executed by the server 116, causes the server to execute the method.

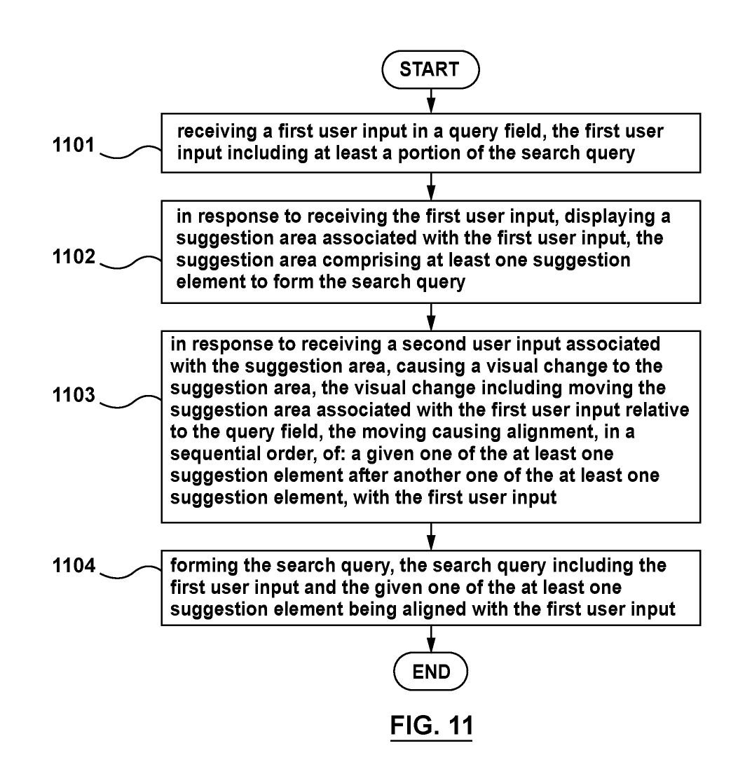

FIG. 11 shows a block diagram of a method 1100, the method 1100 being implemented in accordance with non-limiting embodiments of the present technology.

Step 1101—Receiving a First User Input in a Query Field, the First User Input Including at Least a Portion of the Search Query

The method begins at step 1101, where a user enters the first user input in the query interface 106 of the search application 104 installed on the electronic device 102. The first user input includes at least a portion of the user query. The server 116 receives the portion of the search query from the electronic device 102. As was mentioned before, receiving of a second user input may be implemented using one of the following: mouse control, keyboard control, gesture control, sensor control, voice control to initiate moving animation of the suggestion area. The server 116 receives the portion of the search query via communication link 112.

In some non-limiting embodiments of the present technology, the portion of the search query is sent to the server 116 in the form of a standard URL (uniform resource locator) (i.e., links) encoded in HTML format. In other embodiments of the present technology, the portion of the search query is sent in the form of MYSQL-script. The latter is particularly useful in those non-limiting embodiments of the present technology (and not being limited by them) when the server 116 is a SQL server.

Further, the method 1100 proceeds to step 1102.

Step 1102—in Response to Receiving the First User Input, Displaying a Suggestion Area Associated With the First User Input, the Suggestion Area Comprising at Least One Suggestion Element to Form the Search Query

Method 1100 then executes step 1102, where the server 116 initiates the determination by the suggestion module 142 suggestions to form a search query, a suggestion to complete the query is determined based on the information, which is searched, among other things, within the vertical search domain. The suggestion elements are arranged in suggestion lines, the suggestion lines can additionally contain at least a portion of the most suitable response to the suggestion to form the query.

As described above, the suggestion module 142 can access a plurality of vertical search modules 123 (or a subgroup of a plurality of vertical search modules 123). Further, as an example illustrated in FIG. 4, using a portion of the search query “ [symbol] [symbol] ”, the suggestion module 142 can define (based on some of the above-described algorithms) that the most popular (or most likely) queries associated to the “ [symbol] [symbol] ” are “ [symbol] [symbol] ”, “ [symbol] [symbol] [symbol] [symbol] ”, “ [symbol] [symbol] ”, “ [symbol] [symbol] [symbol] [symbol] [symbol] ”.

Based on the most popular queries, the suggestion module 142 creates four above-mentioned suggestions to complete the query.

Further, the method 1100 proceeds to step 1103.

Step 1103—in Response to Receiving a Second User Input Associated With the Suggestion Area, Causing a Visual Change to the Suggestion Area, the Visual Change Including Moving the Suggestion Area Associated With the First User Input Relative to the Query Field, the Moving Causing Alignment, in a Sequential Order, of: a Given One of the at Least One Suggestion Element After Another One of the at Least One Suggestion Element, With the First User Input

The method 1100 further proceeds to step 1103, where the user enters the second user input and initiates movement of the selected suggestion area until it is aligned with the portion of the search query entered into the query interface 106. The suggestion elements are sequentially added in the query interface 106 to the portion of the entered user query. As it was mentioned before, the second user input associated with the suggestion area may be mouse control, keyboard control, gesture control, touch control, voice control.

In response to receiving the second user input associated with the suggestion area, displaying the movement of the suggestion area associated with the first user input. Thus, the suggestion area is moved relative to the query interface 106 so that when the suggestion area moves, the suggestion elements are subsequently aligned with the portion of the search query in the query interface 106.

Further, the method 1100 proceeds to step 1104.

Stage 1104—Forming the Search Query, the Search Query Including the First User Input and the Given One of the at Least One Suggestion Element Being Aligned With the First User Input

Method 1100 then proceeds to step 1104, where the combination of the user-selected suggestion element with the portion of the search query entered in the query interface 106 occurs. As a result of movement of the suggestion area, the suggestion elements are consistently aligned with the entered portion of the search query in the query interface 106. Thus, the user can form a search query using the selected suggestion element(s) in the suggestion area. To this end, the user can move (e.g., scroll) the suggestion area until the selected suggestion element appears in the query interface 106. If the user does not take any actions relative to the suggestion area and/or the query interface 106 within a predetermined period of time, the user query is considered complete and sent to the server 116. Alternatively, the user enters the third user input associated with the suggestion area to form a query. As it was mentioned before, the third user input associated with the suggestion area may be mouse control, keyboard control, gesture control, touch control, voice control. In addition, if the suggestion bar is displaying not only the suggestion element but also the most suitable answer to the suggestion, the user can quickly select the most suitable response to the suggestion and the query can also be considered complete.

The method 1100 can then terminate.

It should be expressly understood that not all technical results mentioned herein need to be enjoyed in each and every embodiment of the present technology. For example, embodiments of the present technology may be implemented without the user enjoying some of these technical effects, while other embodiments may be implemented with the user enjoying other technical effects.

Modifications and improvements to the above-described implementations of the present technology may become apparent to those skilled in the art.

The foregoing description is intended to be exemplary rather than limiting. The scope of the present technology is therefore intended to be limited solely by the scope of the appended claims.

1. A method for generating a search query suggestion, the search query suggestion for enabling forming a search query on an electronic device having a user input interface for receiving user inputs and a user output interface for providing visual outputs, a network communication interface for two-way communication over the communications network, the method comprises:
receiving a first user input in a query field, the first user input including at least a portion of the search query;
in response to receiving the first user input, displaying a suggestion area associated with the first user input, the suggestion area comprising at least one suggestion element to form the search query;
in response to receiving a second user input associated with the suggestion area, causing a visual change to the suggestion area, the visual change including moving the suggestion area associated with the first user input relative to the query field, the moving causing alignment, in a sequential order, of:
a given one of the at least one suggestion element after another one of the at least one suggestion element, with the first user input;
forming the search query, the search query including the first user input and the given one of the at least one suggestion element being aligned with the first user input.

2. The method of claim 1, wherein the receiving a first user input is implemented based on one of: mouse control, keyboard control, gesture control, sensor control, voice control; the receiving triggering initiation the displaying the suggestion area.

3. The method of claim 1, wherein the receiving a second user input is implemented based on one of: mouse control, keyboard control, gesture control, sensor control, voice control; the receiving triggering initiation the movement of the suggestion area.

4. The method of claim 3, wherein the receiving the second user input using the voice control for the suggestion area comprises:
selecting, by the user, a suggestion element from the suggestion element by uttering the selected suggestion element, said uttering initiating the movement of the suggestion area such that the selected suggestion element is aligned with the portion of the search query in a search field.

5. The method of claim 1, further comprising receiving a third user input associated with a position of the suggestion area corresponding to the given one of the at least one suggestion element aligned with the portion of the search query in the query field.

6. The method of claim 5, wherein the receiving the third user input is implemented based on one of: mouse control, gesture control, sensor control, voice control to initiate movement of the suggestion area.

7. The method of claim 5, further comprising sending the search query to the server responsive to the receiving of the third user input, the third user input identifying the given one of the at least one suggestion element.

8. The method of claim 7, wherein the third user input comprises an identification of the given one of the at least one suggestion element.

9. The method of claim 8, wherein the identification is received in response to the user stopping moving the suggestion area, the given one of the at least one suggestion element being one where the movement has stopped.

10. The method of claim 1, wherein the forming of the search query includes repeating the steps of receiving the first and the second user inputs.

11. The method of claim 1, further comprising sending the search query to the server responsive to lack of user input for a duration of time exceeding a threshold time value associated with a position of the suggestion area corresponding to the given one of the at least one suggestion element.

12. The method of claim 1, wherein displaying the movement of the suggestion area is implemented as moving the suggestion area in a direction that is one of: substantially vertically relative to the query area, substantially horizontally relative to the query area, at least partially substantially circumferentially relative to the query area, at least partially substantially along an arc relative to the query area.

13. The method of claim 1, wherein the moving of the suggestion area comprises moving a feed list of suggestion elements across the query field such that the at least one suggestion element remains displayed after passing through the query field.

14. The method of claim 1, further comprising, in response to receiving at least the first user input, additional displaying of at least a second suggestion area associated with the first user input and containing at least one additional suggestion element for forming the search query.

15. The method of claim 1, further comprising transmitting the at least portion of the search query, via a communication network to a search server, and receiving from the search server an indication of the at least one suggestion element.

16. The method of claim 15, wherein the at least one suggestion element has been determined, by the search server, by executing a vertical search module.

17. The method of claim 1, further comprising displaying an indication of a web-resource determined to be relevant for the search query in the query field.

18. An electronic device for user interaction, the electronic device being configured to send a query to a search server via a communication network, the electronic device comprising:
a user input interface for receiving user inputs,
a user output interface for providing visual outputs,
a network communication interface for two-way communication over the communication network; and
a processor coupled to the user input interface, the user output interface and the network communication interface, and configured to access and execute machine-readable instructions;
the processor being configured to:
receive a first user input in a query field, the first user input including at least a portion of the search query;
in response to receiving the first user input, display a suggestion area associated with the first user input, the suggestion area comprising at least one suggestion element to form the search query;
in response to receiving a second user input associated with the suggestion area, cause a visual change to the suggestion area, the visual change including moving the suggestion area associated with the first user input relative to the query field, the moving causing alignment, in a sequential order, of:
a given one of the at least one suggestion element after another one of the at least one suggestion element, with the first user input;
form the search query, the search query including the first user input and the given one of the at least one suggestion element being aligned with the first user input.
